(19) United States
(12) Patent Application Publication
(10) Pub. No.: US 2022/0382341 A1
(43) Pub. Date: Dec. 1, 2022

(54) COMPUTING DEVICE MOUNTS WITH REMOVABLE SPACERS

(71) Applicant: Hewlett-Packard Development Company, L.P., Spring, TX (US)

(72) Inventors: Yao-Wen Fan, Taipei City (TW); Yu Wei Tan, Taipei City (TW); Yi-Hsieh Chiu, Taipei City (TW)

(73) Assignee: Hewlett-Packard Development Company, L.P., Spring, TX (US)

(21) Appl. No.: 17/772,159

(22) PCT Filed: Nov. 15, 2019
(86) PCT No.: PCT/US2019/061791

§ 371 Date: Apr. 27, 2022

(51) Int. Cl. G06F 1/18

(52) U.S. Cl. CPC G06F 1/182

(57) ABSTRACT

In one example in accordance with the present disclosure, a computing device mount is described. The computing device mount includes a stand to support a computing device and a spacer removably attached to the stand. The spacer is placed in a recess of the computing device to mount the computing device to a mounting surface. The spacer also aligns holes on the computing device with holes on the mounting surface.

### BACKGROUND

Computing devices are becoming more and more common in modern society. A large percentage of the world's population use computing devices every day, and in some cases for a large portion of the day. Computing devices may be positioned in a variety of ways including horizontally, vertically, and even mounted to a surface.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a computing device mount with a removable spacer, according to an example of the principles described herein.

FIG. 2 is an isometric view of the computing device mount with the removable spacer, according to an example of the principles described herein.

FIG. 3 is an isometric view of the stand of the computing device mount, according to an example of the principles described herein.

FIG. 4 is an isometric view of the spacer of the computing device mount, according to an example of the principles described herein.

FIG. 5 is a block diagram of a computing system with a computing device and a computing device mount with a removable spacer, according to an example of the principles described herein.

FIG. 6 is an isometric view of an unassembled computing device with a cover and a removable spacer, according to an example of the principles described herein.

FIG. 7 is an isometric view of an assembled computing device with a cover and a removable spacer, according to an example of the principles described herein.

FIG. 8 is a cross-sectional view of a computing device with a removable spacer, according to an example of the principles described herein.

FIG. 9 is a top view of an unlocked removable spacer in the stand, according to an example of the principles described herein.

FIG. 10 is a top view of a locked removable spacer in the stand, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Computing devices come in all shapes and sizes. For example, desktop computers include towers that are large and intended to be placed on a level horizontal surface such as the floor, a shelf, or a desk. Other computing devices may be smaller. For example, some computing devices may not include certain hardware components such as disk drives, CD/DVD ports, and therefore may be smaller. Such smaller computing devices are more portable and have a wider variety of positioning possibilities. For example, smaller computing devices may be placed horizontally on a horizontal surface, vertically on a horizontal surface, and in some cases may be vertically mounted to either a horizontal or vertical surface such as a computer monitor stand, an underside of a desk, or any other vertical or horizontal mounting surface.

While these small computing devices have expanded in versatility, processing capability, and popularity, some developments may enhance their practical application in society.

Accordingly, the present specification describes a computing device mount. Specifically, the present computing device mount includes a spacer that can be placed in the recess of a computing device housing. The spacer aligns the holes of the computing device to be coaxial with holes in a mounting surface. Proper alignment provided by the spacer prevents deformation/damage to both the computing device and the mounting surface.

The spacer may be stored in a stand of the mount. The stand, when placed on a horizontal surface, may be used to hold a vertically or horizontally aligned computing device. Accordingly, rather than storing the spacer itself in the recess or otherwise on the chassis of the computing device, the spacer may be stored on the stand. As computing device dimensions change with different versions and/or revisions and due to different computing devices having different dimensions, a spacer that is stored in the stand, and not the computing device, can be used by multiple computing devices with different dimensions, and would not be a limitation to be considered when modifying or designing a computing device. For example, were a computing device revised to be smaller, or a new and smaller computing device developed, including a spacer inside the computing device may be a limitation as to the miniaturization of that computing device.

In summary, the present specification describes a removable spacer in a foot stand. The spacer supports the mounting of the computing device to a mounting surface such as a bracket. According to the present specification, the spacer is attached at the bottom end of the foot stand using flexible latches and constrain tabs. To lock the spacer to the foot stand, the spacer is rotated clockwise until the latch of the spacer snaps behind a protrusion of the foot stand. Subsequently, the spacer is fixed in position by tabs of the foot stand. To remove the spacer from the foot stand, for example to use the spacer when mounting the computing device to a mounting surface, the latch is pushed free from the protrusion. Subsequently, the spacer is rotated until the spacer is out of the grip of the tabs of the foot stand.

Specifically, the present specification describes a computing device mount. The computing device mount includes a stand to support a computing device and a spacer removably attached to the stand. During use, the spacer is placed in a recess of the computing device to mount the computing device to a mounting surface. Also during use, the spacer aligns holes on the computing device with holes on the mounting surface.

The present specification also describes a computing system. The computing system includes a computing device with a processor and memory communicatively coupled to the processor. The computing device also includes a recess with holes to affix the computing device to a mounting surface. The computing system also includes a stand to support the computing device and a spacer removably attachable to the stand and the computing device. During use, the spacer is 1) placed in the recess when mounting the computing device to the mounting surface and 2) aligns holes on the computing device with holes on the mounting surface.

The present specification also describes another example of a computing device mount. The computing device mount includes a spacer that rotationally attaches to a stand. The spacer includes a flexible latch to interact with a protrusion on the stand to prevent counterrotation of the spacer when attached to the stand. The stand includes 1) the protrusion to interface with the flexible latch to prevent counterrotation of the spacer and 2) a tab to prevent over rotation of the spacer and retain the spacer juxtaposed against the stand.

Such mounts and systems 1) facilitate the mounting of a computing device to a surface, be it vertical or horizontal; 2) aligns mounting holes and mounting devices used to mount the computing device to the surface; 3) protects against deformation/damage to both the computing device and the mounting surface; and 4) prevents the unintended separation of the computing device from the mounting surface.

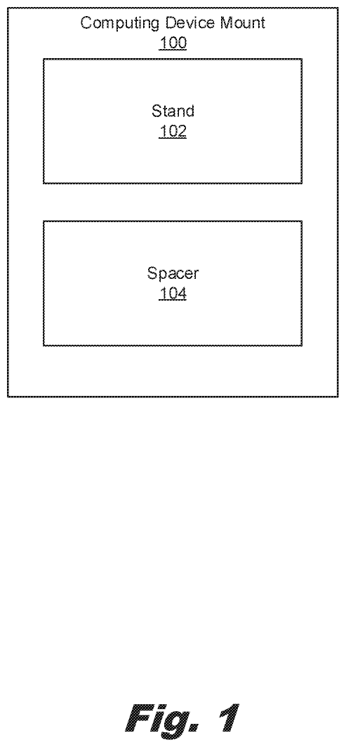

Turning now to the figures, FIG. 1 is a block diagram of a computing device mount (100) with a removable spacer (104), according to an example of the principles described herein. As described, the computing device mount (100) may be used in a number of different ways. For example, the stand (102) may be placed on a horizontal surface and the computing device, which may be a small format computing device, may be placed in either a horizontal or vertical orientation in the stand (102). In another example, the computing device mount (100), and particularly a spacer (104) in the computing device mount (100), may facilitate mounting the computing device to a mounting plate in any number of orientations including a vertical and/or horizontal orientation. That is, a mounting surface may be a bracket or other vertical or horizontal surface. The computing device attaches to this surface via mounting hardware such as screws. The spacer (104) ensures the mounting hardware securely fastens these components together without damage to either.

The stand (102) may be formed of any material including plastic and may have features to retain the computing device in the horizontal and/or vertical position. For example, a top surface of the stand (102) may be flat such that the computing device may be laid horizontally across the stand (102). The top surface of the stand (102) may also include pockets such that when the computing device is stood up vertically, it rests in these pockets such that it can be maintained vertical without risk of tipping over.

The underside of the stand (102) may have a gripping surface, such as rubber feet that adhere the stand (102) to a surface preventing unintentional movement of the stand (102) across the surface. Such unintentional movement may cause the computing device to fall over or be inadvertently knocked off the surface on which it resides, e.g., a desk.

The computing device mount (100) also includes a spacer (104) removably attached to the stand (102). For example, when not using the spacer (104), that is when the computing device is positioned on the stand (102) on a horizontal surface, the spacer (104) may be selectively attached to the stand (102). By comparison, when the spacer (104) is to be used to mount the computing device to a mounting surface, the spacer (104) is removed from the stand (102) and selectively attached to the computing device itself.

As a specific example, the spacer (104) is placed in a recess of the computing device and aligns holes in the mounting surface and the computing device. That is, as described above, without such a spacer, the mounting surface may not be parallel with the computing device housing. This misalignment extends to the holes in respective surfaces through which mounting hardware passes to affix the mounting surface to the computing device. Accordingly, the spacer (104) aligns the holes such that they are coaxial with one another and therefore allows mounting hardware to fit snugly into the holes without compromising their ability to affix the components. Thus, the computing device mount (100) not only facilitates mounting of the computing device to the mounting surface, but does so in a fashion that prevents damage to the computing device and the mounting surface.

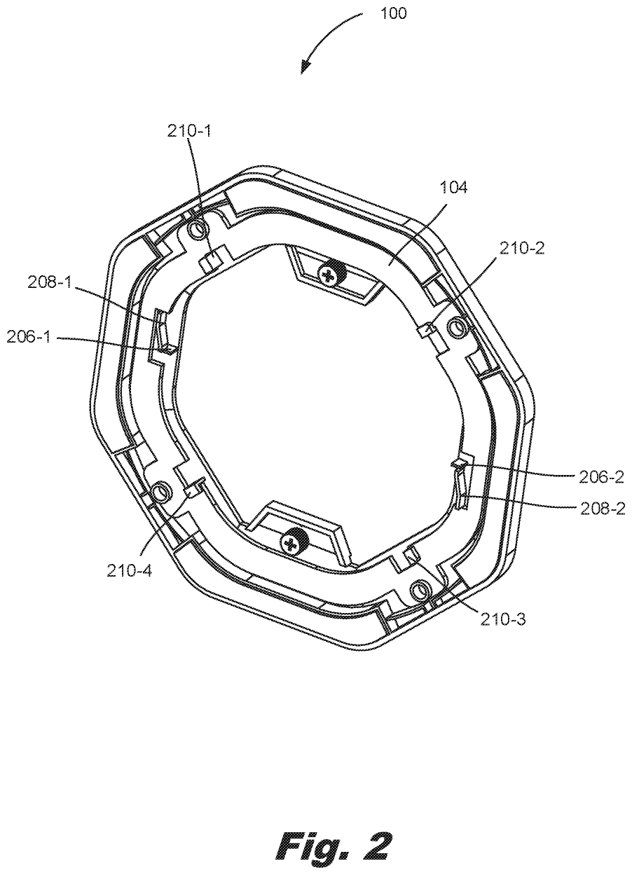

FIG. 2 is an isometric view of the computing device mount (100) with the removable spacer (104), according to an example of the principles described herein. As described above, the spacer (104) may be removably attached to the stand (102). Specifically, the spacer (104) may rotationally attach to the stand (102). That is, to join the spacer (104) to the stand (102), a user rotates the spacer (104) relative to the stand in one direction and to remove the spacer (104) from the stand (102), the user rotates the spacer (104) in the other direction relative to the stand (102). Accordingly, the spacer (104) and the stand (102) include components that facilitate this locking.

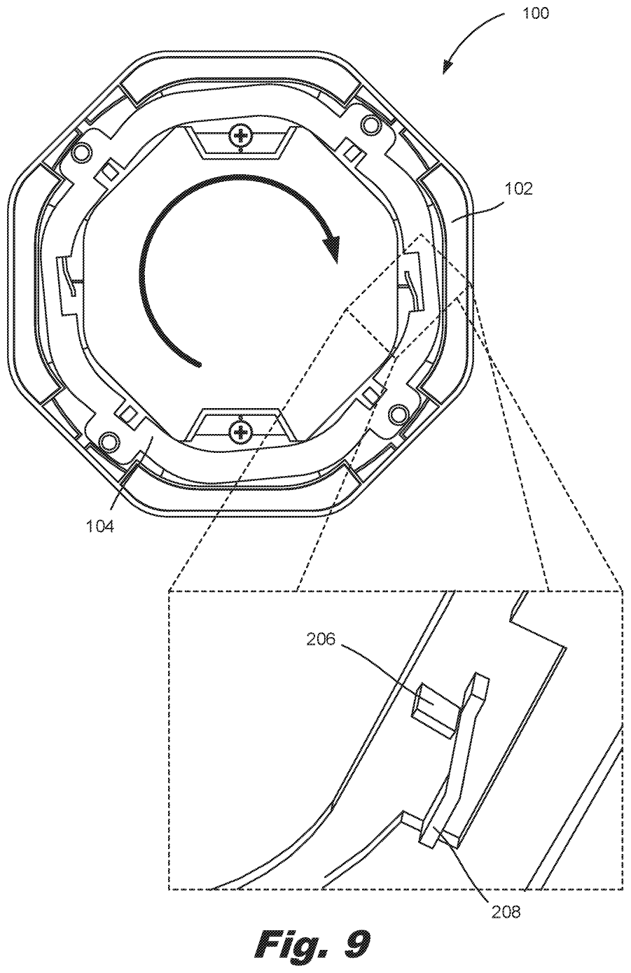

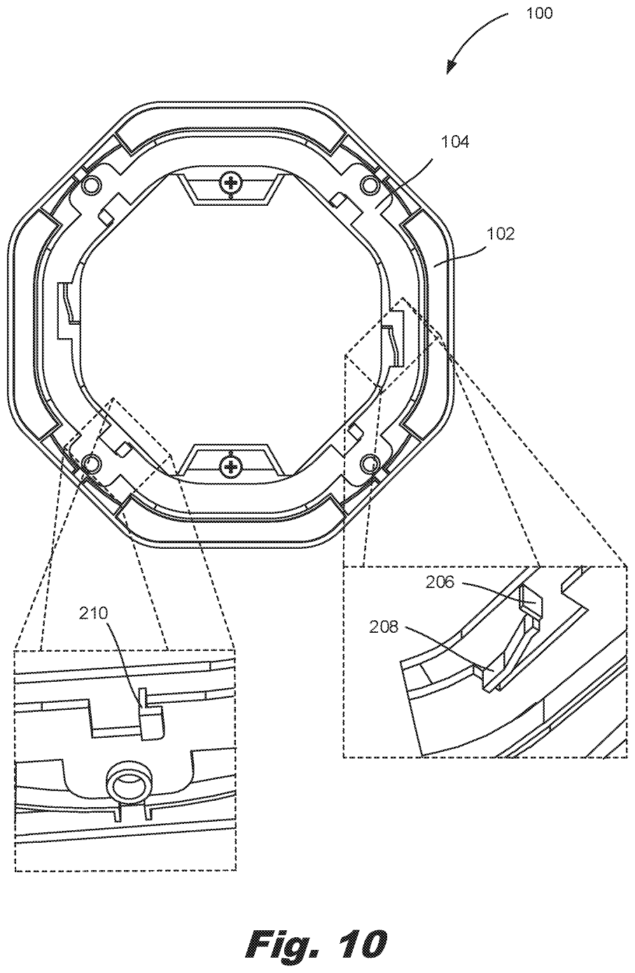

For example, the spacer (104) includes flexible latches (208-1, 208-2) that interact with respective protrusions (206-1, 206-2) on the stand (102) to prevent counterrotation of the spacer (104) when locked. That is, when in a locked position, the latches (208) are blocked from counter rotation by the respective protrusions (206). However, this can be overcome by a user flexing the flexible latch (208) to no longer interface with the protrusions (206). Additional views of the interaction between the flexible latches (206) and protrusions (208) to retain the spacer (104) in place against the stand (102) are provided below in connection with FIGS. 9 and 10.

While FIG. 2 depicts a particular orientation and number of latches (208) and protrusions (206), any variety of orientations and quantities of latches (208)/protrusions (206) may be implemented in accordance with the principles described herein. The flexible latches (208) and the protrusions (206) together may be referred to as a locking mechanism, which retains the spacer (104) in a locked position when attached to the stand (102).

The stand (102) may also include tabs (210-1, 210-2, 210-3, 210-4) to prevent over rotation of the spacer (104) and to retain the spacer (104) juxtaposed against the stand (102). That is, when coupled to the stand (102) and the stand (102) is in a use position with the spacer (104) underneath, the effect of gravity may cause the spacer (104) to separate from the stand (102), notwithstanding the latches (208) and protrusion (206) interaction. Accordingly, the tabs (210) may include a hook such that when in this vertical position, the spacer (104) remains adjacent the stand (102). Moreover, while locking the spacer (104) to the stand (102), if allowed to continually rotate, the spacer (104) may separate from the stand (102). Accordingly, the tab (210), in conjunction with the latches (208) and protrusions (206), ensure the spacer (104) remains coupled to the stand (102) regardless of the orientation of the stand (102)/spacer (104).

As depicted in FIG. 2, the spacer (104) may be disposed on an underside of the stand (102). Accordingly, the top surface of the stand (102), against which the computing device is placed when placed on a horizontal surface, is not affected by the spacer (104) placement. Still in this example, the spacer (104), when attached to the stand (102), is flush with the underside of the stand (102). Were this not the case, the spacer (104) may make the stand (102) unstable, which could cause the computing device to tip over and may potentially become damaged.

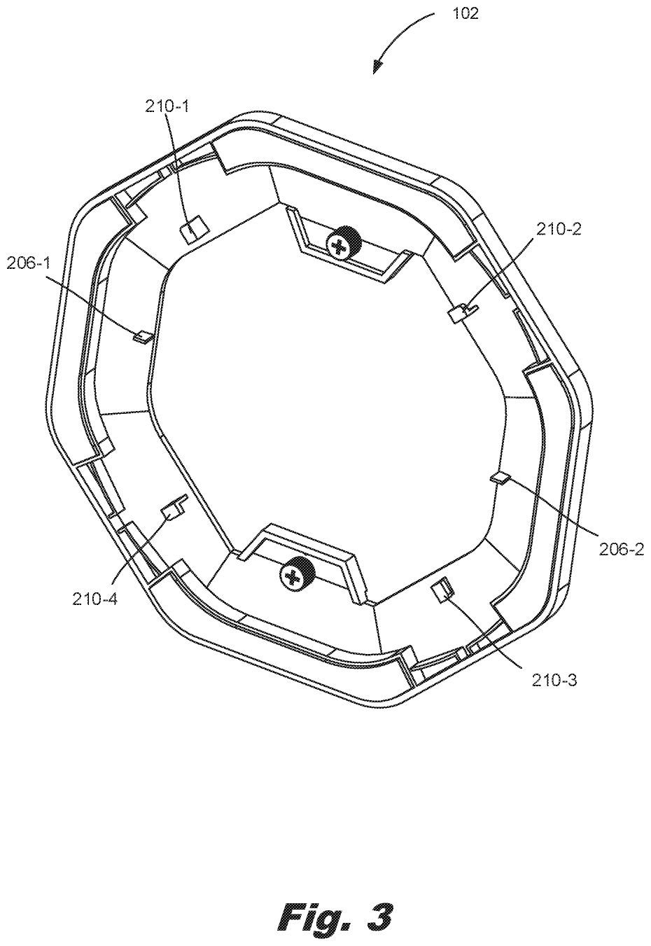

FIG. 3 is an isometric view of the stand (102) of the computing device mount (FIG. 1, 102), according to an example of the principles described herein. More specifically, FIG. 3 is an isometric view of the stand (102) without the removable spacer (FIG. 1, 104) coupled thereto. FIG. 3 depicts the underside as compared to the top surface, which top surface is where the computing device sits in either a horizontal or vertical orientation when the stand (102) is placed on a horizontal surface.

FIG. 3 clearly depicts the protrusions (206-1, 206-2) that the flexible latches (FIG. 2, 208) interact with to keep the spacer (FIG. 1, 104) in place. FIG. 3 also clearly depicts the tabs (210-1, 210-2, 210-3, 210-4) that also help to keep the spacer (FIG. 1, 104) in place when it is stored on the underside of the stand (102).

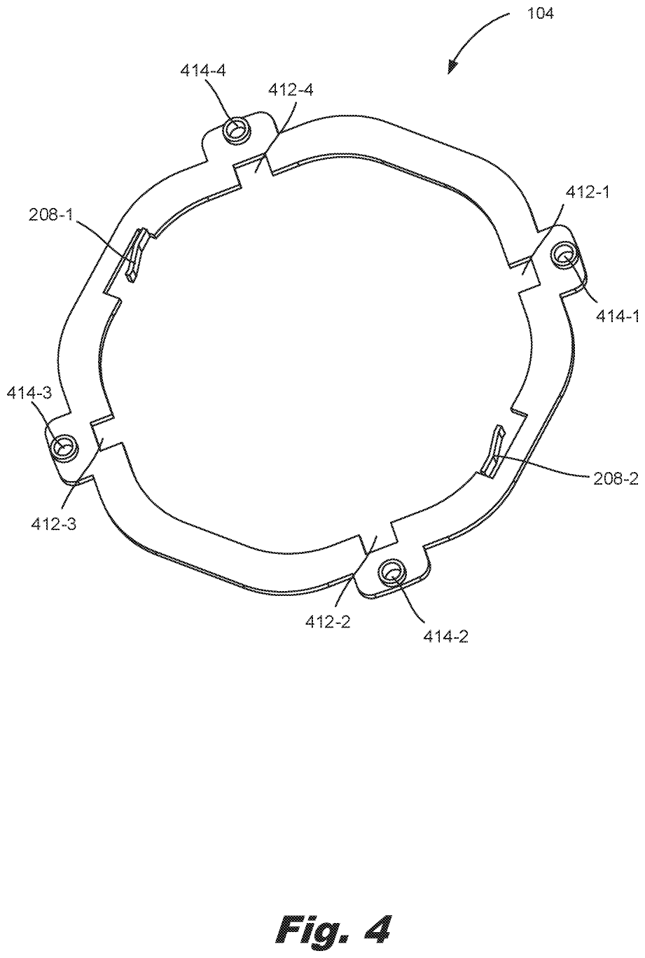

FIG. 4 is an isometric view of the spacer (104) of the computing device mount (FIG. 1, 100), according to an example of the principles described herein. More specifically, FIG. 4 is an isometric view of the spacer (104) detached from the stand (FIG. 1, 102). FIG. 4 clearly shows the flexible latches (208-1, 208-2) that interact with the protrusions (FIG. 2, 206) to retain the spacer (104) in its storage position against the stand (FIG. 1, 102).

FIG. 4 also depicts windows (412-1, 412-2, 412-3, 412-4) through which the tabs (FIG. 2, 210) pass. That is, the spacer (104) is intended to align in a particular orientation relative to the stand (FIG. 1, 102). These windows (412) facilitate this alignment. Specifically, the tabs (FIG. 2, 210), if not aligned with a window (412), prevent the latches (208) and protrusions (FIG. 2, 206) from being on the same plane such that they do not interact with one another and therefore cannot retain the spacer (104) to the stand (FIG. 1, 102). However, if aligned with the windows (412), the tabs (FIG. 2, 210) allow the spacer (104) to be immediately adjacent the stand (FIG. 1, 102).

As depicted in FIG. 4, the spacer (104), in some examples, includes holes (414-1, 414-2, 414-3, 414-4) to align with the holes on the computing device and holes on the mounting surface. That is, as described above, the spacer (104) aligns these two components, and in some examples may include holes through which the mounting hardware passes to ensure the alignment. In other words, the mounting hardware passes through holes on the mounting surface, these holes (414) on the spacer, and into threaded holes on the computing device to mount the computing device to the mounting surface.

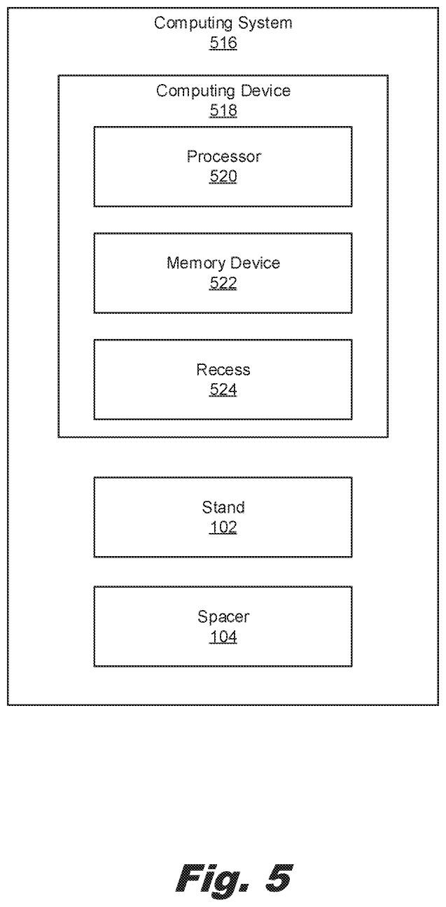

FIG. 5 is a block diagram of a computing system (516) with a computing device (518) and a computing device mount (FIG. 1, 100) with a removable spacer (104), according to an example of the principles described herein.

The computing system (516) includes a computing device (518) which computing device (518) carries out computing operations. The computing device (518) may be of a variety of types including a small format computing device (518) that does not have hard disk drives and disk ports. However, the computing device (518) may be any of a variety of types.

To achieve its desired functionality, the computing device (518) includes various hardware components. Specifically, the computing device (518) includes a processor (520) and a memory device (522) communicatively coupled to the processor (520). The processor (520) includes the hardware architecture to retrieve executable code from the memory device (522) and execute the executable code.

The memory device (522) includes a number of instructions for performing a designated function. The memory device (522) causes the processor (520) to execute the designated function of the instructions.

The memory device (522) may include a computer-readable storage medium, which computer-readable storage medium may contain, or store computer-usable program code for use by or in connection with an instruction execution system, apparatus, or device. The memory device (522) may take many types of memory including volatile and non-volatile memory. For example, the memory device (522) may include Random Access Memory (RAM), Read Only Memory (ROM), optical memory disks, and magnetic disks, among others.

The computing device (518) also includes a recess (524). In this recess (524) is a mechanism that mounts the computing device (518) to a mounting surface. For example, there may be holes disposed in the recess (524) that affix the computing device (518) to a mounting surface. That is, these holes, which may be threaded, are to receive mounting hardware that also passes through holes in a mounting surface. Accordingly, as the mounting hardware, i.e., screws, pass through the holes in the mounting surface and are engaged with the threaded holes in the recess (524), the mounting surface is tightened against the computing device (518) such that it is affixed thereto.

The computing system (516) also includes the stand (102) to support the computing device (518), for example when not mounted to a surface, but rather placed on top of a flat horizontal surface. The computing system (516) also includes the spacer (104) that is placed in the recess (524) when mounting the computing device (518) to the mounting surface and that align holes on the computing device with the holes on the mounting surface.

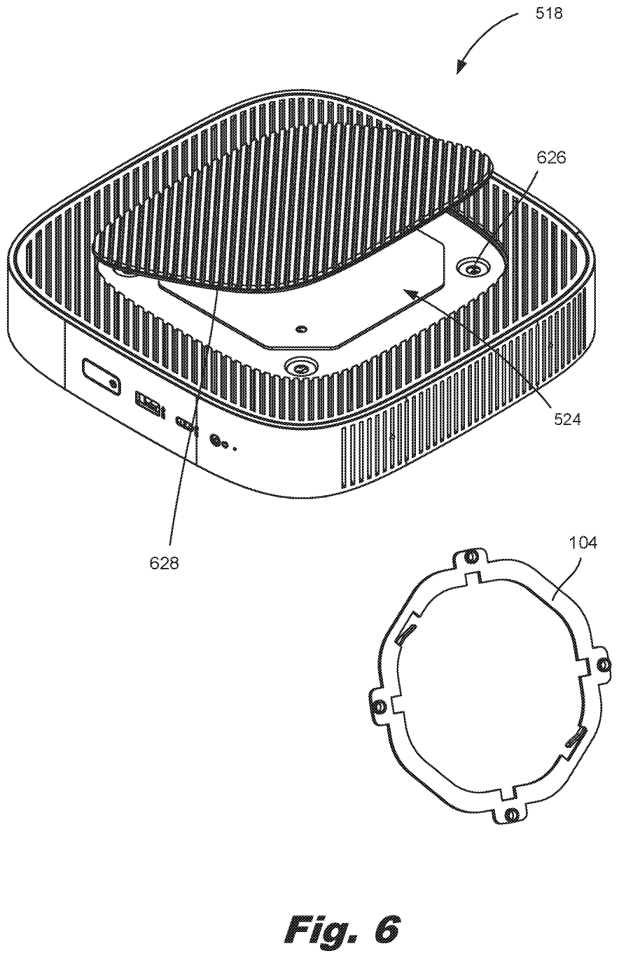

FIG. 6 is an isometric view of an unassembled computing device (518) with a cover (628) and a removable spacer (104), according to an example of the principles described herein. FIG. 6 clearly depicts the recess (524) where the spacer (104) is to be inserted when mounting the computing device (518) to a surface such as an underside of a horizontal surface, a vertical surface, or to a backside of a monitor stand.

FIG. 6 also clearly depicts the holes (626), which may be threaded, and which receive mounting hardware to affix the computing device (518) to the mounting surface. For simplicity, a single hole (626) is identified with a reference number.

In some examples, the computing device (518) includes a cover (628) to hide the recess (524) when the computing device (518) is detached from the mounting surface. Doing so may prevent contaminants or other material from entering the recess (524).

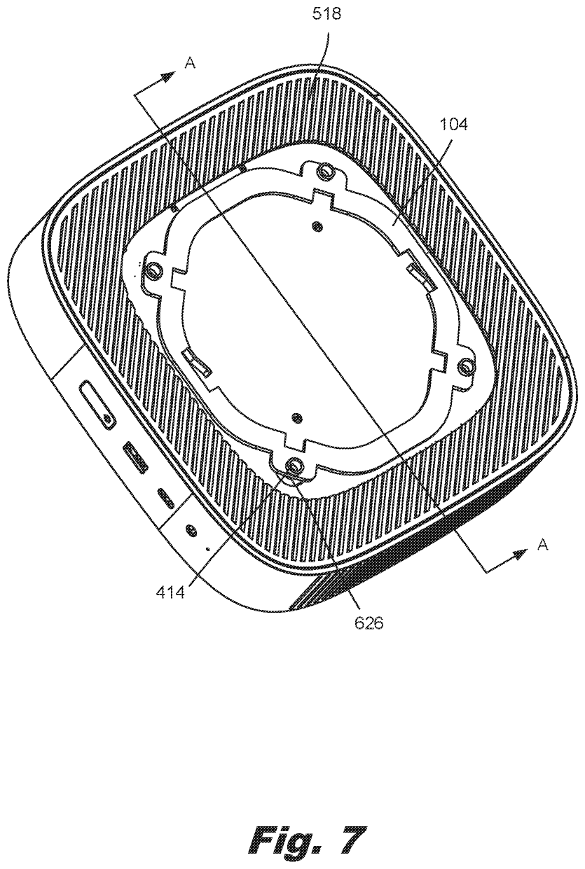

FIG. 7 is an isometric view of an assembled computing device (518) with a cover (FIG. 6, 628) and a removable spacer (104), according to an example of the principles described herein. In FIG. 7, the spacer (104) is in place to allow mounting to a mounting surface such as a bracket. That is, the cover (FIG. 6, 628) has been removed and the spacer (104) is in place. As can be seen in FIG. 7, the holes (414) in the spacer (104) align with the holes (626) in the recess (FIG. 5, 524) such that mounting hardware prevents the spacer (104), which is sandwiched between the computing device (518) and mounting bracket, from moving and further serves to align the holes (626) in the computing device with corresponding holes in the mounting surface.

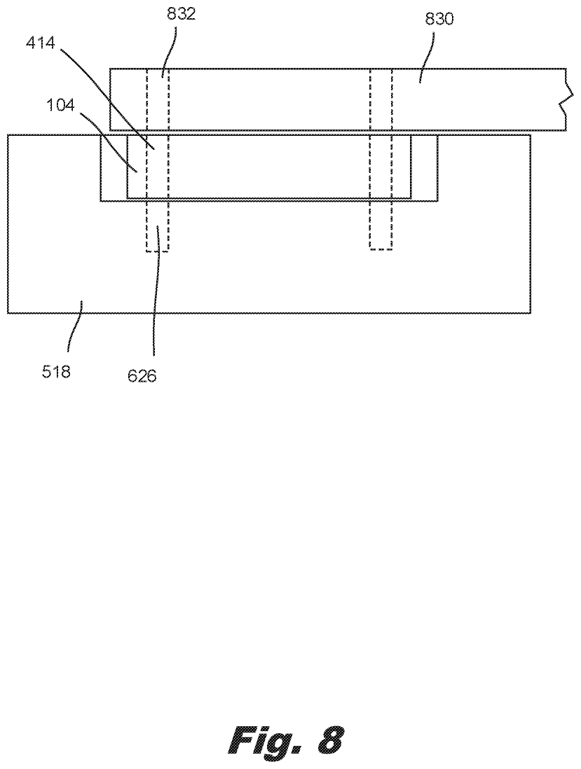

FIG. 8 is a cross-sectional view of a computing device (518) with a removable spacer (104), according to an example of the principles described herein. Specifically, FIG. 8 is a cross-sectional view taken along the line A-A in FIG. 7. Elements in the figure are not necessarily drawn to scale and have been enlarged to illustrate certain aspects of their structure.

As described above, the spacer (104) aligns holes (626) in the computing device (518) with corresponding holes (832) in the mounting surface (830). The mounting surface (830) may take a variety of forms. For example, the mounting surface (830) may be a bracket that attaches to a computer display stand such that the computing device (518) is mounted vertically on the stand. As can be seen in FIG. 8, without such a spacer (104), the mounting surface (830) may angle downwards towards the left in FIG. 8 and would therefore not align with the computing device (518). Such a misalignment may create a wear point on the computing device (518), which wear point may lead to failure of the computing device (518) housing which could lead to damage of the internal computing device (518) components such as the processor (FIG. 5, 520) and/or the memory device (FIG. 5, 522). Without such a spacer (104), the holes (832) of the mounting surface (830) would also not align with respective holes (626) in the recess (FIG. 5, 524) of the computing device (518) which may result in a less secure attachment between the computing device (516) and the mounting surface (830) as misaligned mounting hardware may not hold the components securely together. The misaligned holes (832, 626) may lead to unintended separation of the computing device (518) and the mounting surface (830) which may occur during use and which may also damage the computing device (518) if such failure results in the computing device (518) falling to the ground, as for example when mounted to an underside horizontal surface or a vertical surface.

In some examples, the spacer (104) when attached to the computing device (518), is flush with an external body of the computing device (518) surrounding the recess (524). This ensures that the mounting surface (830) is also flush with, and parallel to, the housing of the computing device (518) as depicted in FIG. 8. The spacer (104) may be the same thickness as the cover (FIG. 6, 628).

FIG. 9 is a view of an unlocked removable spacer (104) in the stand (102), according to an example of the principles described herein. As described above, the removable spacer (104) may lock into place against the stand (102). In some examples, the spacer (104) rotates from an unlocked position to a locked position to attach and detach, respectively, from the stand (102). That is, when placed against the stand (102), the spacer (104) is rotated as indicated by the arrow. At the end of the rotation, the spacer (104) is stored in and retained against the stand (102). As depicted in FIG. 9, the locking mechanism includes the protrusion (206) on the stand (102) and the flexible latch (208) on the spacer (104). During the rotation of the spacer (104) towards the locked position, the flexible latch (208) deflects against the protrusion (206) as depicted in FIG. 9.

FIG. 10 is a view of a locked removable spacer (104) in the stand (102), according to an example of the principles described herein. At the end of the rotation depicted in FIG. 9; the flexible latch (208) rebounds and contacts a surface of the protrusion (206). This prevents the spacer (104) from counterrotating, which counterrotation may lead to inadvertent separation of the spacer (104) and the stand (102). To remove the spacer (104) from the stand (102), a user depresses the flexible latch (208) to deform it and disengage it from the protrusion (206). The user may then rotate the spacer (104) relative to the stand (102) in a direction opposite the arrow depicted in FIG. 9.

FIG. 10 also clearly depicts the tabs (210), which prevent over rotation. That is, the rotation through which the spacer (104) is rotated to lock it into place terminates when the tab (210) contacts the edge of the window (FIG. 4; 414). In this example, the tab (210) also includes a hook to hold the spacer (104) against the stand (102) when in the locked position. That is, as described above, the spacer (104) may be disposed on an underside of the stand (102). Accordingly, when the spacer (104) is stored in the stand (102), and the stand (102) is otherwise being used in an upright orientation; without such hooks, the spacer (104) may simply fall away from the stand (102).

Such mounts and systems 1) facilitate the mounting of a computing device to a surface; be it vertical or horizontal; 2) aligns mounting holes and mounting devices used to mount the computing device to the surface; 3) protects against deformation/damage to both the computing device and the mounting surface; and 4) prevents the unintended separation of the computing device from the mounting surface.

What is claimed is:

1. A computing device mount, comprising:
a stand to support a computing device; and
a spacer removably attached to the stand, the spacer to:
be placed in a recess of the computing device to mount the computing device to a mounting surface; and
align holes on the computing device with holes on the mounting surface.

2. The computing device mount of claim 1, wherein the spacer rotates from an unlocked position to a locked position to attach and detach, respectively, from the stand.

3. The computing device mount of claim 1, further comprising a locking mechanism to retain the spacer in a locked position when attached to the stand.

4. The computing device mount of claim 3, wherein the locking mechanism comprises:
a protrusion on the stand; and
a flexible latch on the spacer, the flexible latch to:
deflect against the protrusion as the spacer rotates towards the locked position; and
rebound and contact a surface of the protrusion when in the locked position.

5. The computing device mount of claim 1, wherein the stand comprises a tab to prevent over rotation of the spacer.

6. The computing device mount of claim 5, wherein the tab comprises a hook to hold the spacer against the stand when in the locked position.

7. The computing device mount of claim 1, wherein the spacer comprises holes to align with the holes on the computing device and the holes on the mounting surface.

8. The computing device mount of claim 1, wherein the spacer, when attached to the stand, is disposed on an underside of the stand.

9. The computing device mount of claim 8, wherein the spacer, when attached to the stand is flush with the underside of the stand.

10. A computing system, comprising:
a computing device comprising:
a processor;
memory communicatively coupled to the processor; and
a recess comprising holes to affix the computing device to a mounting surface;
a stand to support the computing device; and
a spacer removably attachable to the stand and the computing device, the spacer to:
be placed in the recess when mounting the computing device to the mounting surface; and
align holes on the computing device with holes on the mounting surface.

11. The computing system of claim 10, wherein the spacer; when attached to the computing device, is flush with an external body of the computing device surrounding the recessed housing.

12. The computing system of claim 10, further comprising a cover to hide the recessed housing when the computing device is detached from the mounting surface.

13. The computing system of claim 12, wherein the spacer is a same thickness as the cover.

14. A computing device mount, comprising:
a spacer that rotationally attaches to a stand, wherein the spacer comprises:
a flexible latch to interact with a protrusion on the stand to prevent counterrotation of the spacer when attached to the stand; and
the stand, the stand comprising:
the protrusion to interface with the flexible latch to prevent counterrotation of the spacer; and
a tab to prevent over rotation of the spacer and retain the spacer juxtaposed against the stand.

15. The computing device mount of claim 14, wherein responsive to a user force, the flexible latch disengages from the protrusion to allow counter rotation and separation of the spacer form the stand.
